(19) United States
(12) Patent Application Publication
(10) Pub. No.: US 2024/0211216 A1
(43) Pub. Date: Jun. 27, 2024

(54) WORKFORCE APPLICATION DEVELOPMENT SYSTEM

(71) Applicant: Vieaura, Inc., Alpharetta, GA (US)

(72) Inventors: Srinivas R. MORAMPUDI, Alpharetta, GA (US); Shrikant YARLAGADDA, Elmhurst, IL (US)

(21) Appl. No.: 18/145,689

(22) Filed: Dec. 22, 2022

(51) Int. Cl. G06F 8/34; G06T 19/00

(52) U.S. Cl. CPC G06F 8/34; G06T 19/006

(57) ABSTRACT

A system include memory storing instructions, input/output (I/0) operable to present a graphical user interface (GUI), and processor(s) coupled to the memory and the I/0. The processor operable to execute the instructions to: present, via the GUI, options for inputs defining each of a plurality of steps, each definition comprising one or more of: an input to be requested from runtime end user device, an output to be presented on the device, and conditions for one or more of: requesting a defined input via the device, presenting a defined output via the device, proceeding to a subsequent step, and executing iteration(s) of nested step(s); and further operable to receive, via the I/0, each input; generate workforce application instructions from the inputs for a target host computer system and the device; and provision the generated application to the target host for instantiation in the target host and the end user device.

### TECHNICAL FIELD

The present disclosure relates generally to application development, and more particularly in some examples to no-code application development.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

In some aspects, the techniques described herein relate to a workforce application development system, including: a memory operable to store instructions; at least one input/output (I/O) device operable to present at least one graphical user interface (GUI); and at least one processor coupled to the memory and the at least one I/0 device. The processor being operable to execute the instructions to: present, via the at least one GUI, options for one or more developer inputs defining each of a plurality of steps, each definition including one or more of: an input to be requested from a device of a runtime end user device type; an output to be presented on the device; and one or more conditions for one or more of i) requesting a defined input via the device, ii) presenting a defined output via the device, iii) proceeding to a subsequent step, iv) and executing one or more iteration of one or more nested steps; receive, via the at least one I/O device, each developer input; generate workforce application instructions from the received inputs for a target host computer system and the runtime end user device type; and provision the generated workforce application instructions to the target host computer system for workforce application instantiation in the target host computer system and in a device of the runtime end user device type.

In some aspects, the techniques described herein relate to a system, wherein definition of at least one of the steps includes an application program interface (API) call to an application other than the workforce application. In some aspects, the techniques described herein relate to a system, wherein the API call is triggered by a context of an instance of the workforce application. In some aspects, the techniques described herein relate to a system, wherein the one or more conditions include one or more of rules and formulas. In some aspects, the techniques described herein relate to a system, wherein generate includes no-code generation. In some aspects, the techniques described herein relate to a system, wherein at least one output includes an extended reality (XR) output. In some aspects, the techniques described herein relate to a system, wherein the target host computer system is a cloud computing system accessible by the device of the runtime end user device type executing a runtime environment of the workforce application. In some aspects, the techniques described herein relate to a system, wherein developer input further includes enabling an end-user invokable videotelephony function as a component of the workforce application. In some aspects, the techniques described herein relate to a system, wherein the end user device type is a head mounted display. In some aspects, the techniques described herein relate to a system, wherein defining an input includes defining an automatic activation upon the request for a feature of the device for the defined input.

In some aspects, the techniques described herein relate to a non-transitory computer-readable medium storing processor-executable code, the code when read and executed by computer system including, causes the computer system to: present, via at least a graphical user interface (GUI) of the computing system, options for one or more developer inputs defining each of a plurality of steps, each definition including one or more of: an input to be requested from a device of a runtime end user device type; an output to be presented on the device; and one or more conditions for one or more of i) requesting a defined input via the device, ii) presenting a defined output via the device, iii) proceeding to a subsequent step, iv) and executing one or more iteration of one or more nested steps; receive, via at least one I/0 device of the computing system, each developer input; generate workforce application instructions from the received inputs for a target host computer system and the runtime end user device type; and provision the generated workforce application instructions to the target host computer system for workforce application instantiation in the target host computer system and in a device of the runtime end user device type.

In some aspects, the techniques described herein relate to a computer-implemented workforce application development method including: present, via at least a graphical user interface (GUI) of a computing system, options for one or more developer inputs defining each of a plurality of steps, each definition including one or more of: an input to be requested from a device of a runtime end user device type; an output to be presented on the device; and one or more conditions for one or more of i) requesting a defined input via the device, ii) presenting a defined output via the device, iii) proceeding to a subsequent step, iv) and executing one or more iteration of one or more nested steps; receive, via at least one I/O device of the computing system, each developer input; generate, by the computing system, workforce application instructions from the received inputs for a target host computer system and the runtime end user device type; and provision, by the computing system, the generated workforce application instructions to the target host computer system for workforce application instantiation in the target host computer system and in a device of the runtime end user device type.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an architecture, in accordance with examples of the technology disclosed hereon.

FIG. 2 is a flow diagram illustrating methods of workforce application development, in accordance with examples of the technology disclosed herein.

FIG. 3 is a workforce application design interface, in accordance with examples of the technology disclosed hereon.

FIG. 4 is a workforce application design interface, in accordance with examples of the technology disclosed hereon.

FIG. 5 is a flow panel interface, in accordance with examples of the technology disclosed hereon.

FIG. 6 is a workforce application design interface, in accordance with examples of the technology disclosed hereon.

FIG. 7 is a workforce application design interface, in accordance with examples of the technology disclosed hereon.

FIG. 8 is a block diagram of a computing system, in accordance with examples of the technology disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Frontline workers, such as utility company workers in the field, warehouse workers, quality control workers, maintenance workers, and factory workers perform tasks in an organization's operation—often alongside physical assets of the organization. Typically, a worker uses a paper-based approach to performing actions and capturing relevant information as output for recordkeeping. Such information often needs to be re-keyed into downstream computer applications to store and use the information. At times the tasks can be complicated or subject to frequent changes to meet performance or compliance objectives of the organization.

With the advent of mobile devices, their use for operation execution in an organization has varied. Purpose-built end user devices exist that may aid in executing specific tasks, but applications on such devices typically are created using dedicated coding software. Such an approach typically requires software engineering expertise, extensive (and expensive) development environments, and fairly long development times.

Existing approaches to development of workforce applications can be rigidly procedural in their flow. This lack of flexibility in execution and data collection introduces inefficiency. One source of the need for flexibility arises from potential data gaps that can arise. Workarounds to accommodate such gaps typically require significant customization of the workforce application—again, implicating software engineering expertise, extensive (and expensive) development environments, and fairly long development times.

In some organizations, an aging workforce departing for retirement and other sources of attrition have contributed to difficulty in retaining workforce knowledge. Conventional workforce applications often present a steep learning curve for new workers—neglecting the native device friendly characteristics of the emerging workforce and the built-in capabilities of devices familiar to the emerging workforce

Typical workforce applications would benefit from integration with one or more other enterprise applications. Use of such enterprise applications by a workforce application requires technical expertise in application programming interfaces (APIs).

The presence of purpose-built systems under conventional software development can result in workforce application silos and organizational silos. Data movement across workforce applications and across organizations encounters friction and can become overly complex—especially in the face of independently made changes to workforce processes.

The technology disclosed herein is addresses one or more of the shortcomings described above, in part by moving the skill set required to translate an organization's workforce tasks into workforce applications from the software engineering technical realm toward a graphic user interface (GUI) based domain more familiar to work task subject matter experts, and in part by presenting a workforce application development environment that is more flexible, timely, and responsive to implementing changes than the traditional software development environment. In some examples, the technology disclosed herein leverages technologies such as extended reality (XR), cloud computing architecture, lean end-user device runtime environments, and videotelephony to address one or more of the technical issues described above.

In some examples, the technology disclosed herein includes systems, methods, and non-transitory computer readable media storing instruction to systems, computer program product and methods for workforce application development, in which a computer system can present, via a graphical user interface (GUI), options for inputs defining each of a plurality of steps, each definition comprising one or more of: an input to be requested from runtime end user device, an output to be presented on the device, and conditions for one or more of: requesting a defined input via the device, presenting a defined output via the device, proceeding to a subsequent step, and executing iteration(s) of nested step(s); and further operable to receive, via the I/0, each input; generate workforce application instructions from the inputs for a target host computer system and the device; and provision the generated application to the target host for instantiation in the target host and the end user device.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system. By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

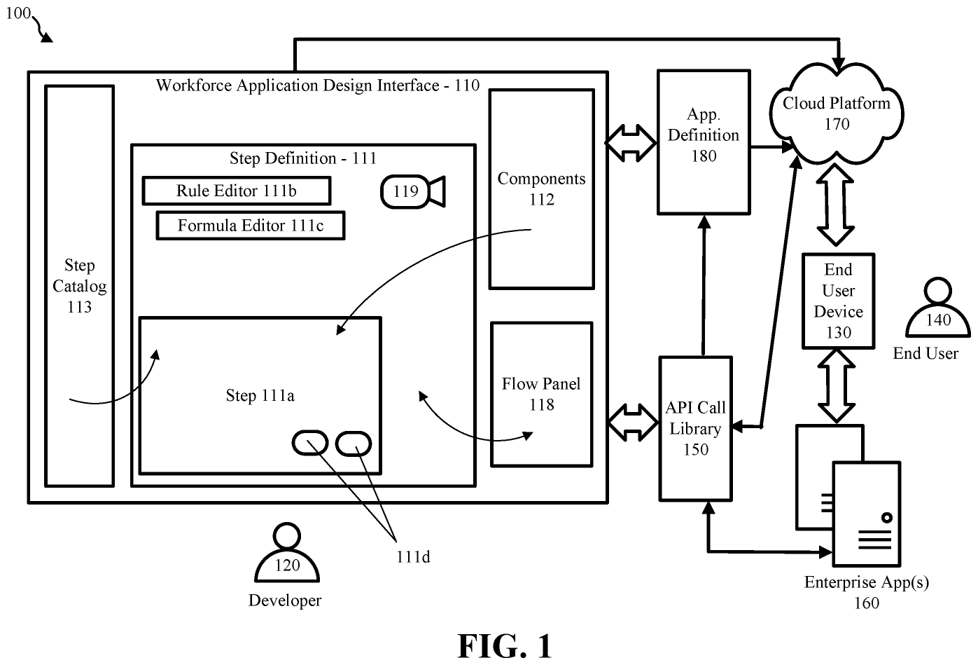

Referring to FIG. 1, an architecture 100 for workforce application development is illustrated, in accordance with examples of the technology disclosed herein. In such an architecture 100, a workforce application design interface 110 presents options to a developer 120 for one or more developer inputs defining each of a plurality of steps of a workforce application. The developer 120 can be a subject matter expert, not necessarily having software development knowledge, skills, or training. Presentation is through a graphical user interface (shown notionally as workforce application design interface 110). Such presentation facilitates using subject matter experts directly over having software engineers translate subject matter domain requirements into the software engineering domain. Such presentation also reduces the time to initial capability and the time to implement revisions and changes over typical approaches.

The workforce application design interface 110 can present options to the developer 120 to define or select a runtime end user device 130 type to be used by end user 140, including specifying certain end user device 130 features, e.g., display resolution, communications options, sensor configuration, etc. End user device 130 can be one or more of any device with communications, display, and user I/0 features, e.g., a head mounted wearable camera, display, and voice interface such as a Realwear^{TM} HMT-1. Other end user devices 130 can be used, such as smart phones, tablet computers, laptop computers, and special-purpose devices. While a hands-free voice interface is used as an example herein for end user device 130, keyboard type interfaces (whether real or virtual) and touch screen type interfaces can also be used.

Step definition 111 includes one or more of defining input(s), output(s), and condition(s) for each step 111a. Controls 111d, such as “redo” and “confirm,” allow the developer 120 control functions such as create, read, update, delete, confirm, proceed to next, return to last with respect to the step 111a under definition. A flow panel 118 provides interactive editing and representation of the flow among defined steps.

An input definition can describe an input to be requested from the end user 140 via a runtime environment of the end user device 130 interacting with an instance of the workforce application that has been provisioned in a communications-accessible platform such as cloud platform 170. Input definition can include identifying one or more input components per step from a set of components 112 available for input and output for the end user device 130 type. For example, an input component can be defined as a voice/sound input through a microphone of the end user device 130. Other input types include, but are not limited to, bar code scan, QR code scan, photo, video (in and out), optical character recognition, location detection, text, check box, numeric (e.g., via a number pad), selected value(s) (mapping input values from prior step(s), API input(s) from mapped API call, counter (numeric value with auto-indexing), time (date, hour, minute, second), and user selection from a discrete number of choices. For example, defining an input as a voice input from the end user 140 choosing, via end user device 130, one option from a list of options “asset in service,” “asset not in service,” and “asset not found.”

In addition, step definition can include specifying a call to an application programming interface (API) from API call library 150 for obtaining input from an external system, for example, from an enterprise application 160 of the organization or of an external party. In some examples, the workforce application design interface 110 provides the capability for the developer 120 to select an API call to be triggered by a context of the workforce application, e.g., scanning a QR code that implicates an enterprise inventory system triggers an API call to the inventory system for data on the item indicated by the QR code.

An output definition can describe an output to be presented to the end user 140. The output can specify one or more of the component 112 types described above that are applicable to output. For example, an output can be a text question with a discrete list (a component 112 type) of possible answers to serve as input. As another example, an output can be a media (e.g., video, audio—a component 112 type) presentation to the end user 140 via the end user device 130. As another example, an output can be an extended reality (XR) image or animation augmenting the end user's 140 view through the end user device 130. As another example, an output can be the display of a numerical keypad—a component 112 type. Output definition for a step can include an API call (from the API call library 150) to an external system, for example, to update an enterprise application 160 asset tracking system of the organization/enterprise with information gathered via an input portion of the step.

Conditions for step definition 111 include one or more of more of i) requesting a defined input via the end user device 130, ii) presenting a defined output via the end user device 130, iii) proceeding to a subsequent step, iv) and executing one or more iterations of one or more nested steps/processes (for example, step(s) from step catalog 113). Each condition can be expressed as a rule (using a rule editor via rules editor selector 111b) or a formula (using formula editor via formula editor selector 111c). Rules and formulas can be based on a context of the application, e.g., a rule can be triggered by a certain context of an instance of the workforce application (e.g., a certain input is received from the end user 140), can take other context of the workforce application (e.g., reading from an environmental sensor of the end user device 130) as a trigger, and can produce an output such as data or control of the flow of the workforce application. As another example, a formula specified for a step can be applied based on the context of an instance of the workforce application (e.g., a certain QR code is read by the end user device 130 executing an instance of the workforce application in cooperation with the instance running on cloud platform 170), can take other context (e.g., a series of numerical data previously provided as data by the user or obtained via an API call from an enterprise application 160) to calculate a result. The result can be used to can produce an output such as data or control of the flow of the workforce application.

In the example of FIG. 1, the architecture 100 generates a workforce application definition 180 as established by the developer 120 for the target host system (e.g., cloud platform 170) and the target user device type (e.g., end user device 130). In some examples, definition and generation of the workforce application is a no-code process, facilitating the direct use of subject matter experts and mitigating the need for software development skills. The workforce application definition 180 is a set of instructions that can be used to instantiate an instance of the workforce application in the target production environment (e.g., the cloud platform 170 and a runtime environment on the end user device 130). These instructions are provisioned to the target host system, e.g., cloud platform 170. In some examples, a runtime environment on end user device 130 interfaces with an instance of the workforce application on cloud platform 170—for example using wireless communications such as Wi-Fi and cellular telephony—to execute the workforce application. In some examples, the end user device communicates independently with enterprise applications 160 as part of executing an instance of the workforce application. In some examples, the end user device communicates with enterprise application via the instance of the workforce application executing on the cloud platform.

In some examples, the workforce application design interface 110 presents an option for the developer to enable a videotelephony function 119 that is invokable by the end user 140 via the runtime environment of an instance of the workforce application executing on the end user device 130. In some examples, a selectable output component includes an XR output, e.g., projecting an image of a part onto the see-through display of an end user's headset, including allowing operations on the XR output such as scale (e.g., in one or two dimensions), flip, rotate, and adjust transparency. As one such XR example, consider selecting a semitransparent image of a muffler to be replaced. End user operations available on the image include rotating and scaling the image so that the XR image appears in the position that the replacement muffler will occupy on the vehicle being worked on. In some examples, the developer 120 can select automatic activation of an API upon performance of an action by the end user 140, e.g., upon scanning a bar code, an API for querying an inventory system is activated using the scanned bar code information.

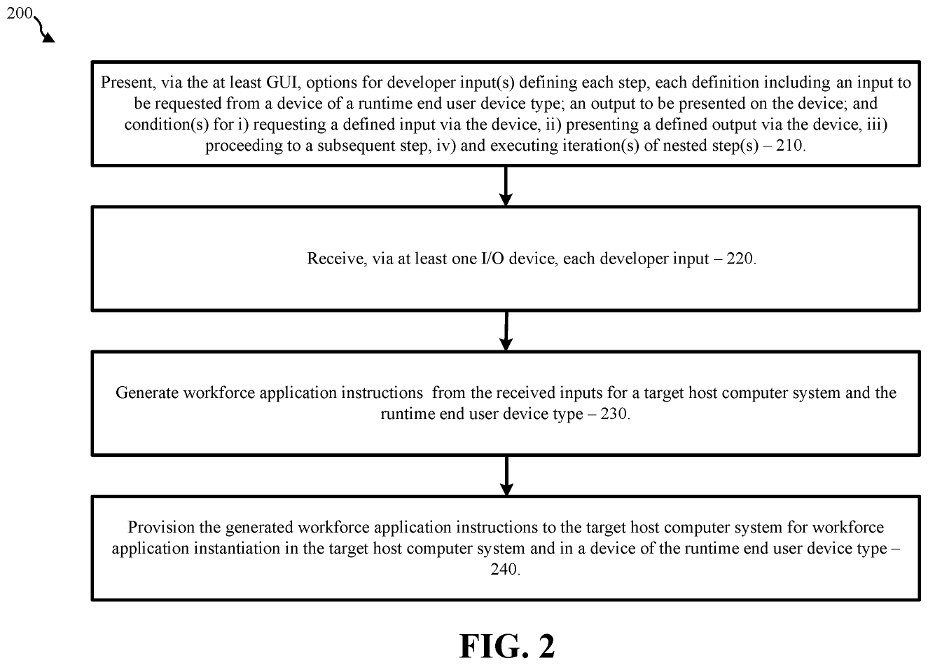

Referring to FIG. 2 and continuing to refer to FIG. 1 for context, methods 200 for wireless communication are illustrated, in accordance with examples of the technology disclosed herein. In such methods 200, a computing device presents, via a graphical user interface (GUI) of a computing system, options for one or more developer inputs defining each of a plurality of steps—Block 210. Each definition can include one or more of an input, an output, and one or more conditions. Each input can be an input to be requested from a device of a runtime end user device 130 type. Each output can be an output to be presented on the end user device 130. Each condition can be for one or more of i) requesting a defined input via the end user device 130, ii) presenting a defined output via the end user device 130, iii) proceeding to a subsequent step, iv) and executing one or more iteration of one or more nested steps.

In some such methods, definition of at least one of the steps includes specifying an application program interface (API) call to an application other than the workforce application. In some such methods the API call is triggered by a context of an instance of the workforce application. In some such methods, at least one output comprises an extended reality (XR) output. In some such methods, the one or more conditions comprise one or more of rules and formulas.

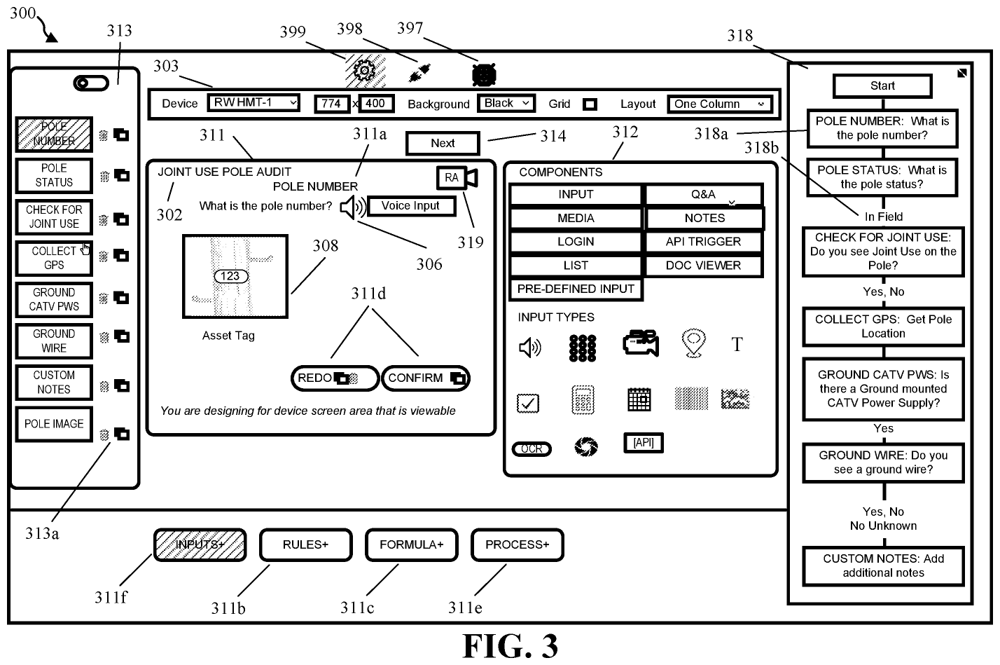

In an example of FIG. 3 and continuing to refer to prior figures for context, a workforce application design interface 300, similar to workforce application design interface 110, is illustrated, in accordance with examples of the technology disclosed herein. The workforce application name is “JOINT USE POLE AUDIT” 302. Note that highlighting symbol 399 indicates that the interface 300 is in step definition mode; symbol 398 would be highlighted to indicate API mode (e.g., allowing creation of API based on organization spec or review/validate existing API mapping or update current mapping or delete a mapping); symbol 397 would be highlighted for generation of instructions 180.

Interface 300 presents options for a developer 120 to select an end user device 130 type and device display characteristics such as resolution, background, and layout in banner 303. Flow panel 318 (similar to flow panel 118) provides interactive representation and editing of the flow among defined steps. Step catalog 313 (similar to step catalog 113) provides editable step definitions (without being tied to context in a flow), from which step definitions can be reused. In some examples, steps can be entered into the step catalog 313 prior to a given workforce application design. Controls for deleting or copying a step are also provided as step catalog controls 313a. Selecting the step opens the step for edit in the step definition 311 window (similar to step definition 111 window).

Controls 311d (similar to controls 111d) such as “redo” and “confirm,” allow the developer 120 control functions such as create, read, update, delete, confirm, return to last with respect to the step 311a under definition—though a proceed to next step control is shown as button 314. Components 312 are presented for developer 120 selection as described above regarding components 112 with respect to FIG. 1. A remote assistance control 319 (similar to remote assistance video telephony control 119) is provided in the step definition 311 window. Inputs selector 311f provides access to the component's editor 312. Rules selector 311b (e.g., rules editor selector 111b) provides access to the rules editor discussed elsewhere herein. Formula selector 311c (e.g., formula editor selector 111c) provides access to the formula editor discussed elsewhere herein. Process selector 311e provides access to existing processes for nesting in the step under edit in step definition 311. These selectors are positioned outside step definition 311 in the example of FIG. 3.

At least one I/O of the computing system receives each developer input—Block 220. In the example of FIG. 3, the developer 120 used banner 303 to specify that the end user device 130 will be of type “RW HMT01” with a “774×400” display area used for the workforce application on the end user device. A “Black” background was chosen, though a see-through extended reality (XR) background can also be chosen by the developer 120. No “Grid” is selected, and a “One Column” layout has been selected by the developer 120.

Several steps (e.g., step 318a) and conditions (e.g., “in field” 318b is one among three answers to “What is the pole status?” before proceeding to different next steps depending on the answer) already entered by the developer 120 are shown. The illustrated step 311a for which the GUI presents options is “POLE NUMBER.” An input component of input type “voice” 306 has been chosen by the developer 120 from components 312 (e.g., components 112), with the prompt “What is the pole number” as adjacent text. A media component 308 of an image of a pole with an asset tag “123” also was defined as a component of the step 311a.

Computer executable workforce application instructions are generated from the received inputs for a target host computer system and the runtime environment end user device 130 type—Block 230. In the example of FIG. 3, selection of the generate symbol 397 generates code that can be provisioned on the cloud platform 170 for instantiation and execution with end user device 130.

The generated workforce application is provisioned to the target host computer system for workforce application instantiation in the target host computer system and the runtime end user device type—Block 240.

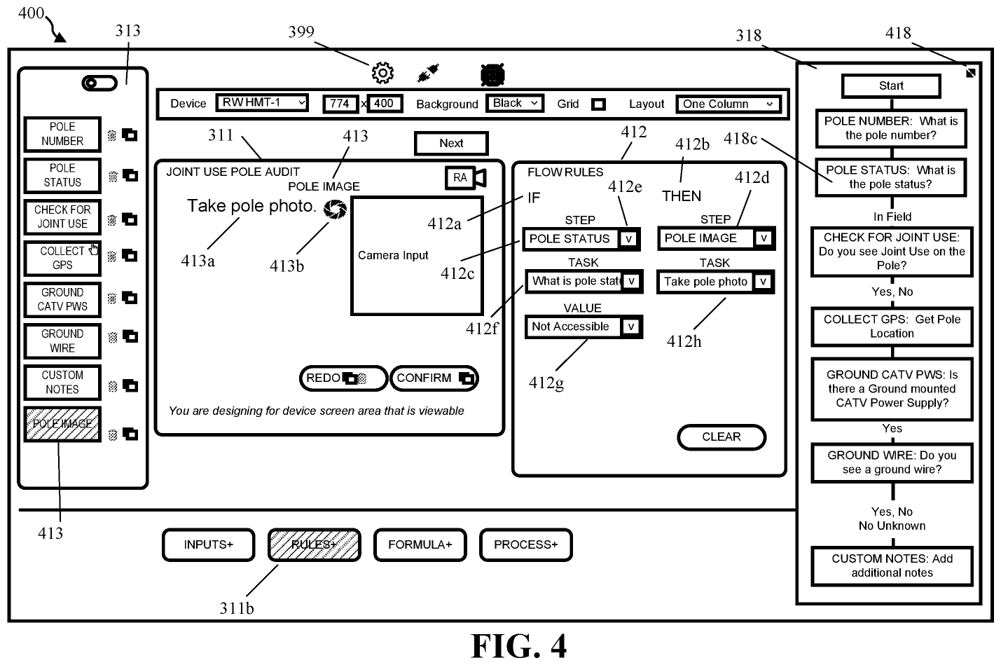

Referring to FIG. 4 and continuing to refer to prior figures for context, a workforce application design interface 400 (similar to workforce application design interface 110 and interface 300) is illustrated, in accordance with examples of the technology disclosed herein. Interface 400 is an example of rules creation/editing for a workforce application, in particular rules for proceeding from one step to one or more other steps. In the example of interface 400, developer 120 selected the “POLE IMAGE” step 413 from step catalog 313. The “POLE IMAGE” step 413 appears in the step definition 311 window for the “JOINT POLE USE AUDIT” workforce application. Inputs task/text 413a, camera input 413b have been defined by the developer 120 for the “POLE IMAGE” step 413.

The developer 120 selected rules editor 412 (e.g., using selector 311b), which appears as a “FLOW RULES” window 412 where the inputs editor 311a window for components 312 appeared in an earlier figure. Rules editor 412 is presented with an “IF” column 412a and a “THEN” column 412b. Each of column 412a and column 412b starts with a “STEP” identification, e.g., step selection 412c and step selection 412d that can be used with a pull-down menu, e.g., pull down menu 412e that lists steps from step catalog 313 and flow panel 318.

The developer 120 selected the “POLE STATUS” step 418c for the step of “IF” column 412a, which populated task selection 412f with a list of tasks under the selected step (in this case only one task “What is the pole status”). The developer 120 selected (in this case by default) the “What is pole status” task selection 412f, which populated value selection 412g with a list of the values already entered by the developer for the “What is pole status” task.

The developer 120 selected the “Not Accessible” value selection from among the list of values. Note that the flow panel 318 shows only the “In Field” value for the “What is pole status” task.

The developer 120 selected the “POLE IMAGE” step 413 for the step 412d of “THEN” column 412b, which populated task selection 412h with a list of tasks under the selected step (in this case only one task “Take pole photo” 413a). The developer 120 selected (in this case by default) the “Take pole photo” task selection 412h.

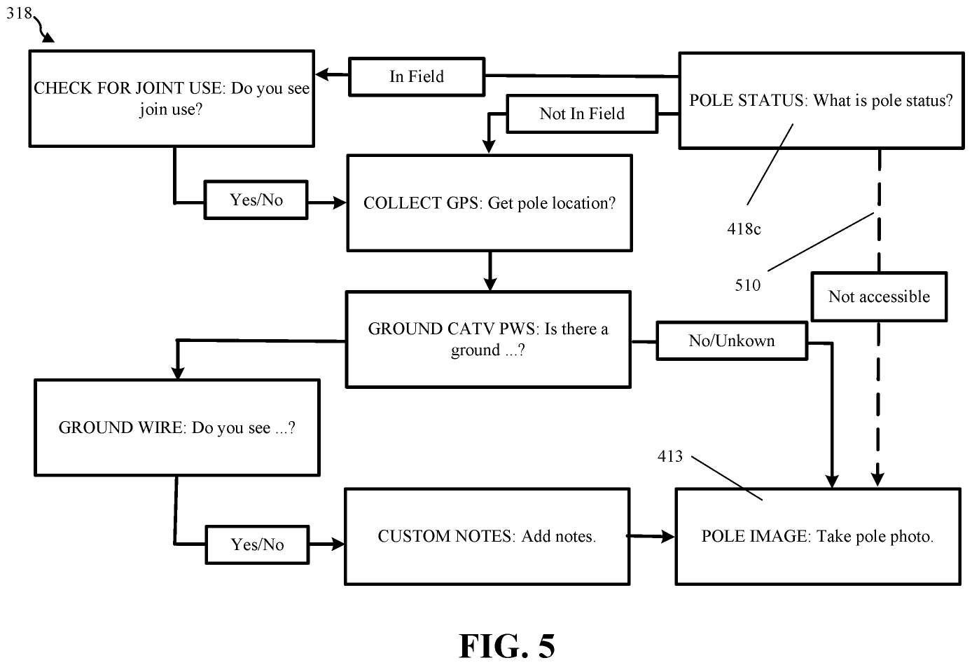

The present example allowed the developer 120 to create the step relationship for when the value for “What is pole status” is “Not Accessible” between already defined step “POLE STATUS” 418c and task “What is pole status” and the step “POLE IMAGE” 413 currently under definition in the window for step definition 311. Referring to FIG. 5 and continuing to refer to prior figures for context, flow panel 318 is shown in expanded view. Flow panel 318 was expanded by the developer 120 by selecting control 418. Expanded flow panel 318 show the newly created relationship 510 between the step “POLE STATUS” 418c and the step “POLE IMAGE” 413 when “What is pole status” is “Not Accessible.” Separate relationships can be created for various values of other tasks,

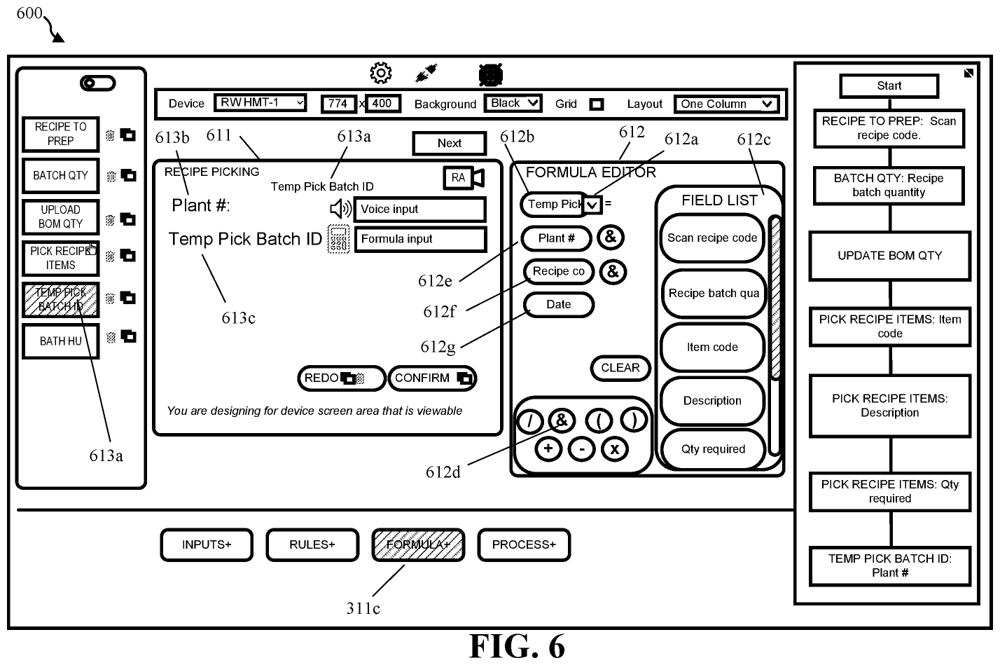

Referring to FIG. 6 and continuing to refer to prior figures for context, a workforce application design interface 600 (similar to workforce application design interface 110 and interface 300) is illustrated, in accordance with examples of the technology disclosed herein. Interface 600 is an example of formula creation/editing for a workforce application. In the example of interface 600, the developer selected the formula editor selector 311c, which presented the formula editor 612. Step definition 611 (similar to step definition 311) indicates that step 613a “TEMP PICK BATCH ID” was selected by the developer 120. The “Plant #” field 613b is indicated as a voice input, and the “Temp Pick Batch ID” field 613c is indicated as a “Formula input.” The developer 120 used pull-down menu 612a to select to specify “Temp pick batch ID” 612b. The developer 120 used fields from field list 612c and the “&” concatenation operator 612d to specify “Temp pick batch ID” 612b as a concatenation of “Plant #” 612e “&” “Recipe code” 612f “&” “Date” 612g.

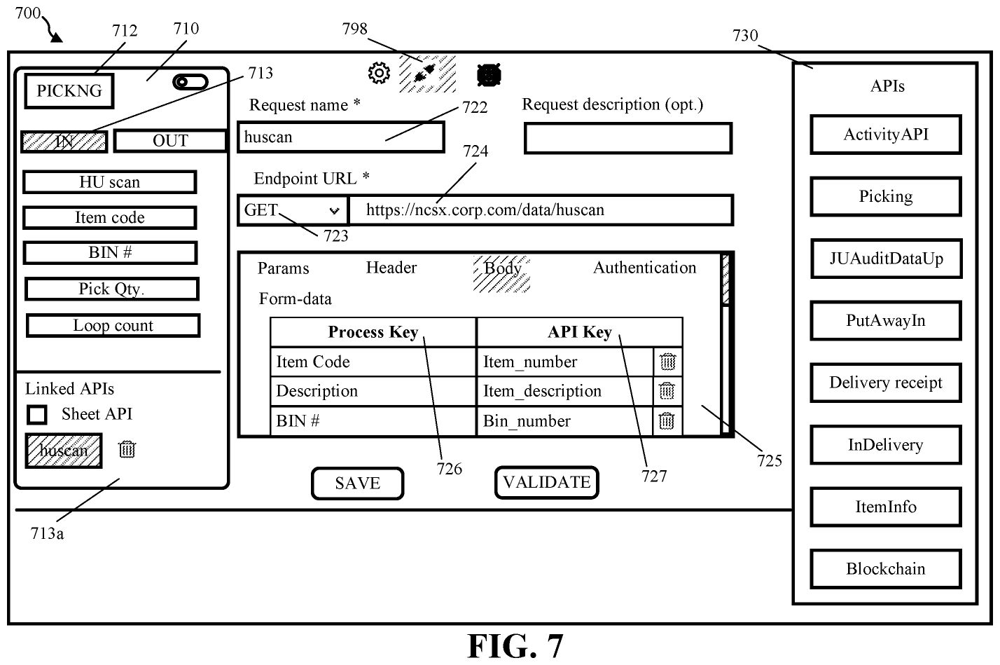

Referring to FIG. 7 and continuing to refer to prior figures for context, a workforce application design interface 700 (similar to workforce application design interface 110 and interface 300) is illustrated for “PICKING” 712 items from stock, in accordance with examples of the technology disclosed herein. Interface 700 is an example of use of an API in a workforce application.

In this example, a haul unit (HU) is container associated with a list of items to be picked by the end user 140 from bins in a warehouse. Upon the end user 140 scanning an identifier (e.g., bar code, QR code) of the HU while running the “HU: Scan Hauling Unit” in the workforce application, an API is triggered to access an enterprise application 160 for the list of items to be picked (e.g., the “Item Code,” “Description,” “BIN #,” and “Pick Qty” for each item to be picked) and placed in the HU. For each item in turn, the workforce application populates list data into the workforce application display on the end user device 130. The “BIN #” field of the “PICK ITEM” step prompts the end user 140 to scan the bin from which the end user 140 picks one or more items corresponding to the “Item Code.” Upon a mismatch between the scan and the “BIN #” from the enterprise application 160, a separate workflow (not shown) is entered to reconcile the discrepancy. Similarly, the “Pick Qty” field prompts the end user 140 to provide voice input confirming the quantity of the item picked from the bin. Upon a discrepancy between the data from the enterprise application 160 and the data from the end user 140 via voice input to the end user device 130, a separate workflow (not shown) is entered to reconcile the discrepancy.

In the example of interface 700, developer 120 selected API selector 798 (e.g., symbol 398) to display the APIs linked to a workforce application that included the steps: [1] “HU: Scan Hauling Unit” and multiple iterations of the step [2] “PICK ITEM.” Step [2] has four tasks, i.e., enter “Item Code,” “Description,” “BIN #,” and “Pick Qty.” As described above, when an identifier of the HU is scanned, one or more APIs to one or more enterprise applications 160 are triggered to populate values in each of the four tasks. Interface 700 allows the developer 120 to create and edit each API linked to the workforce application.

Panel 710 indicates that the workforce application for which the interface is displaying information is the “PICKING” application 712. The developer 120 selected the “IN” API type selector 713, which causes panel 710 to display the inbound (from a data perspective) APIs used in the workforce application. Specifically, details for the API “huscan,” as indicated by data window 722, are shown. Selector 723 also specifies that “huscan” is a data-inbound API as a “GET” API, versus a “PUT” API. The universal resource locator (URL) for the API of the enterprise application 160 is shown in window 724. The Linked APIs section 714 of panel 710 show the APIs currently linked to the particular workforce application. In addition, a “Sheet API” can establish an interface with a spreadsheet for one or both of input data (e.g., for a pre-filled form) and output data (e.g., gathered by sensors on the end user device 130).

Window 725 shows the huscan GET body, including the mapping of process keys column 726 of the workforce application to API keys column 727 for the enterprise application 160. While the API keys column 727 is dictated by the API published/exposed by the enterprise application 160, the present technology allows a developer 120 to create and edit this mapping of each item in the process keys column 726 to an API keys column 727 parameter. Window 739 shows the APIs available in the API call library 150.

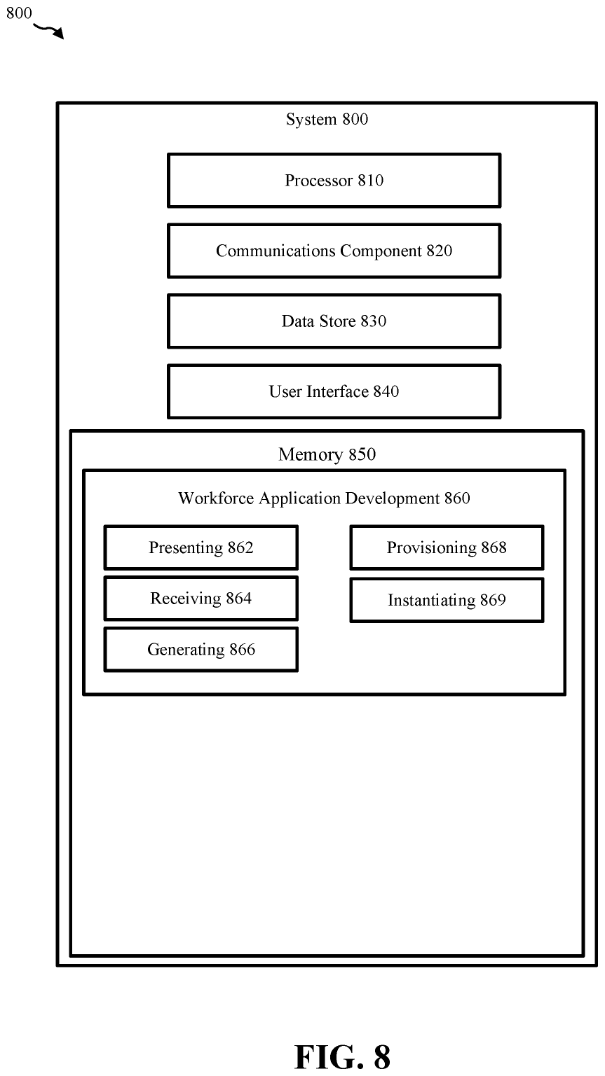

FIG. 8 illustrates an example of a workforce application development system 800 including optional component details. In one aspect, system 800 includes one or more processors 810 for carrying out processing functions associated with one or more of components and functions described herein. Each processor 810 can include a single or multiple set of processors or multi-core processors. Moreover, processor 810 can be implemented as an integrated processing system and/or a distributed processing system.

System 800 further includes memory 850, e.g., for storing local versions of operating systems (or components thereof) and/or applications being executed by processor 810, such as workforce application development component 860. Memory 850 can include a type of memory usable by a computer, such as random access memory (RAM), read only memory (ROM), tapes, magnetic discs, optical discs, volatile memory, non-volatile memory, and any combination thereof.

Further, system 800 may include a communications component 820 that provides for establishing and maintaining communications with one or more other devices, parties, entities, etc. utilizing hardware, software, and services as described herein. Communications component 820 may carry communications between components in system 800, as well as between system 800 and external devices, such as devices located across a communications network and/or devices serially or locally connected to system 800. For example, communications component 820 may include one or more buses, and may further include transmit chain components and receive chain components associated with a wireless or wired transmitter and receiver, respectively, operable for interfacing with external devices.

Additionally, system 800 may include a data store 830, which can be a combination of hardware and/or software, that provides for mass storage of information, databases, and programs employed in connection with aspects described herein. For example, data store 830 may be or may include a data repository for operating systems (or components thereof), applications, related parameters, etc. not currently being executed by processor 810. In addition, data store 830 may be a data repository for the workforce application development component 860.

System 800 may optionally include a user interface component 840 operable to receive inputs from a user of system 800 (e.g., datacenter maintenance personnel) and further operable to generate outputs for presentation to the user. User interface component 840 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, a switch/button, any other mechanism capable of receiving an input from a user, or any combination thereof. Further, user interface component 840 may include one or more output devices, including but not limited to a display, a speaker, a haptic feedback mechanism, a printer, any other mechanism capable of presenting an output to a user, or any combination thereof.

The system 800 includes workforce application development component 860, which includes presenting component 862. Presenting component 862 presents, via a GUI, options for one or more developer inputs defining each of a plurality of steps, each definition comprising one or more of: an input to be requested from a device of a runtime end user device type; an output to be presented on the device; and one or more conditions for one or more of i) requesting a defined input via the device, ii) presenting a defined output via the device, iii) proceeding to a subsequent step, iv) and executing one or more iteration of one or more nested steps. Accordingly, presenting component 862 may provide means for presenting, via a GUI, options for one or more developer inputs defining each of a plurality of steps, each definition comprising one or more of: an input to be requested from a device of a runtime end user device type; an output to be presented on the device; and one or more conditions for one or more of i) requesting a defined input via the device, ii) presenting a defined output via the device, iii) proceeding to a subsequent step, iv) and executing one or more iteration of one or more nested steps.

Workforce application development component 860 includes receiving component 864. Receiving component 864 receives, via the at least one I/0 device, each developer input. Accordingly, receiving component 864 may provide means for receiving, via the at least one I/0 device, each developer input.

Workforce application development component 860 includes generating component 866. Generating component 866 generates workforce application instructions from the received inputs for a target host computer system and the runtime end user device type. Accordingly, generating component 866 may provide means for generating workforce application instructions from the received inputs for a target host computer system and the runtime end user device type.

Workforce application development component 860 includes provisioning component 868. Provisioning component 868 provisions the generated workforce application instructions to the target host computer system for workforce application instantiation in the target host computer system and in a device of the runtime end user device type. Accordingly, provisioning component 868 may provide means for provisioning the generated workforce application instructions to the target host computer system for workforce application instantiation in the target host computer system and in a device of the runtime end user device type.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

We claim:

1. A workforce application development system, comprising:
a memory operable to store instructions;
at least one input/output (I/0) device operable to present at least one graphical user interface (GUI); and
at least one processor coupled to the memory and the at least one I/0 device, the processor operable to execute the instructions to:
present, via the at least GUI, options for one or more developer inputs defining each of a plurality of steps, each definition comprising one or more of:
an input to be requested from a device of a runtime end user device type;
an output to be presented on the device; and
one or more conditions for one or more of i) requesting a defined input via the device, ii) presenting a defined output via the device, iii) proceeding to a subsequent step, iv) and executing one or more iteration of one or more nested steps;
receive, via the at least one I/O device, each developer input;
generate workforce application instructions from the received inputs for a target host computer system and the runtime end user device type; and
provision the generated workforce application instructions to the target host computer system for workforce application instantiation in the target host computer system and in a device of the runtime end user device type.

2. The system of claim 1, wherein definition of at least one of the steps comprises an application program interface (API) call to an application other than the workforce application.

3. The system of claim 2, wherein the API call is triggered by a context of an instance of the workforce application.

4. The system of claim 1, wherein the one or more conditions comprise one or more of rules and formulas.

5. The system of claim 1, wherein generate comprises no-code generation.

6. The system of claim 1, wherein at least one output comprises an extended reality (XR) output.

7. The system of claim 1, wherein the target host computer system is a cloud computing system accessible by the device of the runtime end user device type executing a runtime environment of the workforce application.

8. The system of claim 1, wherein developer input further comprises enabling an end-user invokable videotelephony function as a component of the workforce application.

9. The system of claim 1, wherein the end user device type is a head mounted display.

10. The system of claim 1, wherein defining an input comprises defining an automatic activation upon the request for a feature of the device for the defined input.

11. A non-transitory computer-readable medium storing processor-executable code, the code when read and executed by computer system comprising, causes the computer system to:
present, via at least a graphical user interface (GUI) of the computing system, options for one or more developer inputs defining each of a plurality of steps, each definition comprising one or more of:
an input to be requested from a device of a runtime end user device type;
an output to be presented on the device; and
one or more conditions for one or more of i) requesting a defined input via the device, ii) presenting a defined output via the device, iii) proceeding to a subsequent step, iv) and executing one or more iteration of one or more nested steps;
receive, via at least one I/0 device of the computing system, each developer input;
generate workforce application instructions from the received inputs for a target host computer system and the runtime end user device type; and
provision the generated workforce application instructions to the target host computer system for workforce application instantiation in the target host computer system and in a device of the runtime end user device type.

12. The computer-readable medium of claim 11, wherein definition of at least one of the steps comprises an application program interface (API) call to an application other than the workforce application.

13. The computer-readable medium of claim 12, wherein the API call is triggered by a context of an instance of the workforce application.

14. The computer-readable medium of claim 11, wherein the one or more conditions comprise one or more of rules and formulas.

15. The computer-readable medium of claim 11, wherein generate comprises no-code generation.

16. A computer-implemented workforce application development method comprising:
present, via at least a graphical user interface (GUI) of a computing system, options for one or more developer inputs defining each of a plurality of steps, each definition comprising one or more of:
an input to be requested from a device of a runtime end user device type;
an output to be presented on the device; and
one or more conditions for one or more of i) requesting a defined input via the device, ii) presenting a defined output via the device, iii) proceeding to a subsequent step, iv) and executing one or more iteration of one or more nested steps;
receive, via at least one I/0 device of the computing system, each developer input;
generate, by the computing system, workforce application instructions from the received inputs for a target host computer system and the runtime end user device type; and
provision, by the computing system, the generated workforce application instructions to the target host computer system for workforce application instantiation in the target host computer system and in a device of the runtime end user device type.

17. The method of claim 16, wherein the target host computer system is a cloud computing system accessible by the device of the runtime end user device type executing a runtime environment of the workforce application.

18. The method of claim 16, wherein developer input further comprises enabling an end-user invokable videotelephony function as a component of the workforce application.

19. The method of claim 16, wherein the end user device type is a head mounted display.

20. The method of claim 16, wherein defining an input comprises defining an automatic activation upon the request for a feature of the device for the defined input.
